(19) United States
(12) Patent Application Publication
(10) Pub. No.: US 2025/0328324 A1
(43) Pub. Date: Oct. 23, 2025

(54) ISOLATING CODE FOR FASTER VERIFICATION AND IMPROVED MODULARIZATION

(71) Applicant: Technology Innovation Institute - Sole Proprietorship LLC, Masdar City (AE)

(72) Inventors: Ridhi Jain, Abu Dhabi (AE); Norbert Tihanyi, Abu Dhabi (AE)

(73) Assignee: Technology Innovation Institute - Sole Proprietorship LLC, Masdar City (AE)

(21) Appl. No.: 19/096,838

(22) Filed: Apr. 1, 2025

Related U.S. Application Data
(60) Provisional application No. 63/637,194, filed on Apr. 22, 2024.

(51) Int. Cl. G06F 8/41

(52) U.S. Cl. CPC G06F 8/433

(57) ABSTRACT

The present embodiments relate to systems, methods, and computer-readable media for isolating a portion of input source code using a backward flow analysis. A target property can be selected in a set of input source code that includes one or more properties. A backward flow analysis of the target property to identify a subset of nodes or instructions that modify or impact the attributes of the target property. The backward flow analysis can include tracing dependencies of the one or more properties in the set of input source code, identifying one or more compute nodes that either read or write attributes, and determining a subset of nodes or instructions that modify the target property. An output code module can be generated for the target property that includes the subset of nodes or instructions.

### CROSS-REFERENCE TO RELATED APPLICATIONS

This application claims priority to U.S. Provisional Application No. 63/637,194, filed Apr. 22, 2024, which is incorporated by reference in its entirety.

### TECHNICAL FIELD

This disclosure relates to systems, methods, and computer-readable media for isolation of code of a target within a set of source code.

### BACKGROUND

Many software programs include large amounts of instructions that, when executed, cause one or more computing devices to execute various tasks. For instance, a machine learning code library implements a system that can receive a text-based query, process the query to generate a response, and provide the response to the user. Many such libraries can have multiple functions that can interact between one another to perform these tasks.

Further, as software programs continually grow in complexity and scale, debugging and verifying aspects of these programs is important to ensure a desired result is achieved when executing each instruction. Generally, operators can manually and/or automatically perform a debugging or verification process to verify the accuracy of the instructions included in these programs. For instance, verification can include inspecting a number of instructions to ensure that a desired result will occur upon execution of each instruction. However, performing debugging or verification processes can be inefficient and resource-intensive, particularly when reviewing large and complex software programs.

### SUMMARY

The present embodiments relate to systems, methods, and computer-readable media for isolating a portion of input source code using a backward flow analysis. A target property can be defined in a set of input source code that includes one or more properties. A backward flow analysis of the target property to identify a subset of instructions that modify or impact the attributes of the target property. The backward flow analysis can include tracing dependencies of the one or more properties in the set of input source code, identifying one or more compute nodes that affect attributes, and determining a subset of nodes or instructions that: (i) include an identified compute node that writes to any attribute that modifies any of the first set of attributes in the target property or (ii) include a path that exists between a first compute node that writes a first attribute and a second compute node associated with the target property that reads the first attribute without the first attribute being redefined by any intervening compute node. An output code module can be generated for the target property that includes the subset of nodes/instructions.

In the first example, a computer implemented method is described. The computer-implemented method can include obtaining a set of input source code that may include one or more properties. The computer-implemented method may also include detecting a selection of a target property in the set of input source code. The computer-implemented method may also include performing a backward flow analysis of the target property.

Performing the backward flow analysis from the target property can include identifying a first set of attributes that are part of the target property. Performing the backward flow analysis on the target property can also include tracing dependencies of the one or more properties in the set of input source code. Performing the backward flow analysis of the target property can also include identifying, for each of the one or more properties, one or more compute nodes that either read or write attributes. Performing the backward flow analysis from the target property can also include determining a subset of nodes/instructions that (i) include an identified compute node that writes to any attribute that modifies any of the first set of attributes in the target property or (ii) include a path that exists between a first compute node that writes a first attribute and a second compute node associated with the target property that reads the first attribute without the first attribute being redefined by any intervening compute node. The computer-implemented method can also include generating an output code module that may include at least the subset of nodes or instructions.

In some instances, the backward flow analysis further may include identifying a second subset of nodes/instructions that are processed subsequent to the target property and do not modify any of the first set of attributes that are part of the target property and removing each of the second subset of nodes or instructions from the number of properties to be traced as part of the backward flow analysis for the target property.

In some instances, the backward flow analysis further may include identifying a third subset of nodes or instructions that include properties that only read data to one or more compute nodes and removing each of the third subset of nodes or instructions from the number of properties to be traced as part of performing the backward flow analysis for the target property.

In some instances, identifying compute nodes that read or write variables further includes retrieving data for each of the compute nodes in a file structure and identifying a modification of any variable to the compute nodes in response to execution of each property.

In some instances, the embodiments may also include performing a verification process of the output code module.

In some instances, the output code module includes a text-based graphical representation of the subset of nodes or instructions.

In some instances, the output code module is a text-based or graphical representation of each of the first subset of nodes or instructions and the second subset of nodes or instructions.

In some instances, the embodiments may also include identifying the target property as a first instruction, identifying at least one other instruction in the set of input source code, and generating, for each identified instruction, output code modules using the backward flow analysis with attributes specific to each instruction.

In another example, a computer-readable storage medium containing program instructions for a method being executed by an application is provided. The application can include code for one or more components that are called by the application during runtime. Execution of the program instructions by one or more processors of a computer system causes the one or more processors to perform steps.

The steps can include obtaining a set of input source code that may include one or more properties. The steps can also include detecting a selection of a target property in the set of input source code. The steps can also include performing a backward flow analysis of the target property.

Performing the backward flow analysis of the target property can include identifying a first set of attributes that are part of the target property. Performing the backward flow analysis from the target property can also include tracing dependencies of a number of the one or more nodes/instructions in the set of input source code. Performing the backward flow analysis of the target property can also include identifying a first subset of nodes/instructions that are processed subsequent to the target property and do not modify any of the first set of attributes that are part of the target property. Performing the backward flow analysis of the target property can also include identifying a second subset of nodes or instructions that include properties that only read attributes to one or more compute nodes. Performing the backward flow analysis from the target property can also include removing each of the first subset of nodes/instructions and the second subset of nodes/instructions from nodes/instructions considered in performing the backward flow analysis for the target property determining a third subset of nodes or instructions that each include an identified compute node that writes any attribute that modifies any of the first set of attribute in the target property and a fourth subset of nodes or instructions that each include a path between a first compute node that writes a first attribute and a second compute node associated with the target property that reads the first attribute without the first attribute being redefined by any intervening compute node.

The steps can also include generating an output code module that may include at least the third subset of nodes/instructions and the fourth set of nodes/instructions.

In another example, a method is provided. The method can include obtaining a set of input source code that may include one or more properties. The method may also include detecting a selection of a target property in the set of input source code. The method may also include performing a backward flow analysis of the target property. Performing the backward flow analysis of the target property can include identifying a first set of variables that are part of the target property. Performing the backward flow analysis of the target property can also include tracing dependencies of a number of properties in the set of input source code. Performing the backward flow analysis of the target property can also include identifying, for each of the number of properties, one or more compute nodes that either read or write variables. Performing the backward flow analysis of the target property can also include determining a first subset of nodes or instructions that each include an identified compute node that writes any variable that modifies any of the first set of variables in the target property. Performing the backward flow analysis of the target property can also include determining a second subset of nodes or instructions that each include a path that exists between a first compute node that writes a first variable and a second compute node associated with the target property that reads the first variable without the first variable being redefined by any intervening compute node.

The method can also include generating an output code module that may include at least the first subset of nodes or instructions and the second set of nodes or instructions.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 is an example high-level flow process for isolating code, according to an embodiment.

FIG. 2 is an example illustration of a property-wise code reduction system, according to an embodiment.

FIGS. 3A-3C illustrate an example flow process for isolating code for a software program, according to an embodiment.

FIGS. 4A-4C illustrate a second example flow process for isolating code for a software program, according to an embodiment.

FIG. 5 illustrates an example set of nodes and corresponding instructions dependent to each target property, according to an embodiment.

FIGS. 6A-6B are example flow processes for isolating code in a set of input source code using a backward flow analysis according to an embodiment.

FIG. 7 is a block diagram of a special-purpose computer system according to an embodiment.

### DETAILED DESCRIPTION

Software programs are generally used to implement various functionalities in a variety of contexts. An example software program can implement a large language model (LLM), a type of machine learning model that can perform a variety of natural language processing (NLP) tasks such as generating and classifying text, answering questions in a conversational manner, and translating text from one language to another. Other example software programs can implement various automation tasks, control systems, etc.

Further, many software programs can include a plurality of functions that perform different tasks using many different variables. For instance, an LLM can have separate functions for obtaining a query, performing NLP on the query, generating a response to the query, and transmitting the response to the query to the requesting device. Each function of these software programs can include thousands of instructions that utilize unique sets of attributes (variables, objects) in performing these tasks.

Further, the growth of complexity and scale of software programs can make verification and analysis of the instructions used in each function very difficult and resource intensive. Particularly, parsing through thousands of instructions and variables can require a high level of computing and processing resources. Further, unverified instructions and variables can lead to inaccurate results and/or inefficient processing in executing the instructions in the program. For instance, inaccurate instructions can lead to unintended errors that can cause a loop in processing or can lead to multiple attempts to run the program, which can lead to an inefficient use of computing and power resources.

In many instances, an attribute (e.g., variable, value, object) of a target property to be verified may not be impacted by each statement that is part of the entire software program. For example, a given variable can impact statements relating to processing of a first function (e.g., performing NLP of a query in a LLM model) but may not be relevant or used in statements that are part of a second function (e.g., generating a response to the query) for the software program. Accordingly, only a subset of the instructions in the software program may actually modify the attributes for a target property, and reviewing other instructions may be unnecessary and inefficient.

Parsing such software programs and performing a debugging and verification process of a software program can have various considerations. For example, debugging and verifying code can be a time-consuming task that can take hours or days for a user to find the root cause of a problem. Further, the complexity of many software programs can make it difficult to pinpoint the exact source of the issue. Debugging and verifying a large software program can require significant resources, including computing power, storage space, and human expertise, which can increase the cost of development and maintenance. Further, verifying a large software program can be an inefficient process, as it may require multiple iterations of testing and debugging to resolve the issue, which can further increase the time and resources required.

Isolating target properties (along with all dependent nodes) into independent isolated output code modules can allow for verification of only a small subset of the overall software program that focuses only on properties and instructions that modify attributes of the target. For instance, an operator can perform verification on an output code module that includes only a small percentage of an overall software program to verify aspects of a specific target. In this example, the operator does not need to parse the entire software program to attempt to identify relevant properties and cause unnecessary verification of properties that do not modify the target.

Additionally, in many cases, a single function may not represent an independent functionality. A combination of several functions may be used together to implement a specific functionality of a software program. Accordingly, given that many programs can have complex interactions between multiple functions, isolating target properties across multiple functions can allow for verification to be performed with increased efficiency.

The present embodiments relate to systems, methods, and computer-readable media for isolating a portion of input source code using a backward flow analysis. A target property can be selected in a set of input source code that includes one or more properties. A backward flow analysis of the target property to identify a subset of nodes or instructions that modify or impact the attributes of the target property. The backward flow analysis can include tracing dependencies of the one or more properties in the set of input source code, identifying one or more compute nodes that either read or write attributes, and determining a subset of nodes or instructions that: (i) include an identified compute node that writes to any attribute that modifies any of the first set of attributes in the target property or (ii) include a path that exists between a first compute node that writes a first attribute and a second compute node associated with the target property that reads the first attribute without the first attribute being redefined by any intervening compute node. An output code module can be generated for the target property that includes the subset of nodes or instructions.

Isolating functionally cohesive code from the software can significantly increase efficiency in performing a program verification process. Particularly, the present embodiments can break down complex software programs into output code modules that are smaller and self-contained and that are each responsible for a targeted functionality or feature of the software program.

The output code modules can allow for focusing on verifying smaller amounts of instructions and variables with a clear and more well-defined purpose. Further, the present embodiments can foster improved code organization and encapsulation, which can increase code readability and maintainability. Moreover, a modular design of isolating parts of a software program can provide independent verification of individual components, enabling parallel efforts by multiple verification processes, thereby reducing the overall verification time and resources used in verifying code.

Further, integration testing can be more straightforward with well-defined interfaces between modules, where each output code module can already be verified through individual verification processes. Furthermore, this modular approach can encourage code reuse and can promote the adoption of well-tested libraries, enhancing the overall reliability of the software. Embracing functionality-wise division can empower developers to confidently tackle the complexity of modern software systems, promoting a robust verification culture that paves the way for more reliable and secure software applications.

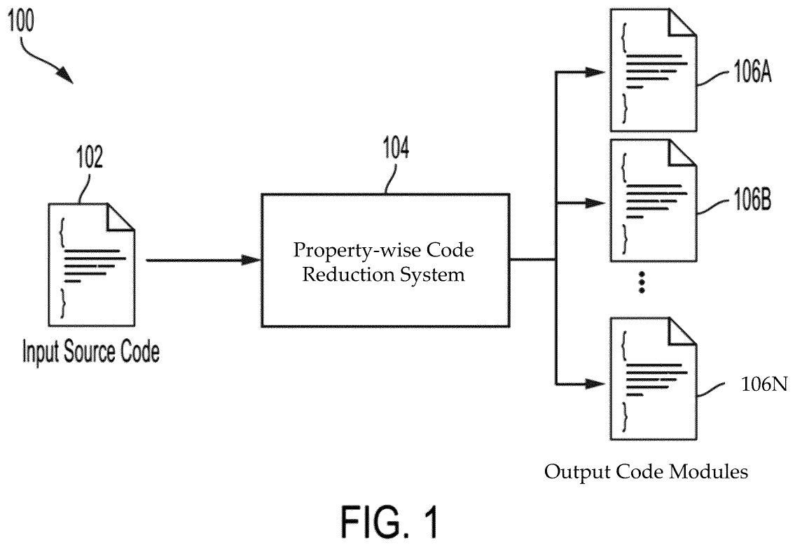

FIG. 1 is an example high-level flow process 100 for isolating code as described herein. As shown in FIG. 1, input source code 102 can be obtained. Input source code 102 can include software programs implementing various functionalities, such as a system that can handle hypertext transfer protocol (HTTP) requests and independently backs up the data periodically, a control system, etc. Input source code 102 can include large volumes of instructions and variables that can be isolated into a number of output code modules (e.g., 106A-N) as described herein.

In FIG. 1, a property-wise code reduction system 104 can process the input source code 102 can generate output code modules 106A, 106B, 106N using a backwards flow analysis process. For example, the property-wise code reduction system 104 can detect a selection of a target property (e.g., by a selection of a user or automatic selection of a specific instruction) and perform a backwards flow analysis for the target property as described herein. The property-wise code reduction system 104 can generate output code modules 106A-N for each target property. In some instances, an output code module 106A-N can be generated for each of a set of target properties identified in the input source code.

The output code modules 106A-N can include isolated portions of the input source code 102 that are each are based on a target property and independently contain dependencies for each target. Any number of output code modules 106A-N can be generated based on a size and/or a number of target properties for the input source code 102 to improve efficiency in isolating target properties and verifying code as described herein.

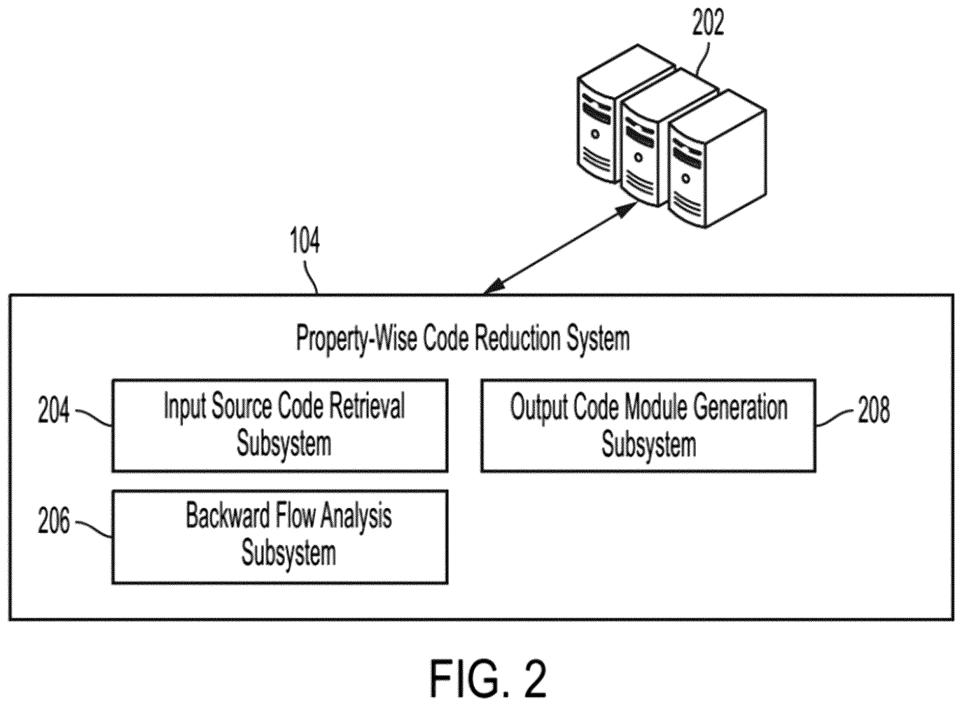

FIG. 2 further illustrates a property-wise code reduction system 104 according to some embodiments. As shown in FIG. 2, one or more computing devices, such as a series of interconnected computing devices 202, can implement the property-wise code reduction system 104 as described herein. The property-wise code reduction system 104 can include an input source code retrieval subsystem 204, a backward flow analysis subsystem 206, and an output code module generation subsystem 208.

The input source code retrieval subsystem 204 can obtain input source code either at the computing devices 202 or another computing device. For instance, the input source code can be downloaded from another computing device or cloud computing platform.

The backward flow analysis subsystem 206 can identify a subset of nodes or instructions in the input source code that modify the target property as part of a backward flow analysis process. For instance, the input source code can include a series of instructions, with a target property including an instruction with attributes (e.g., variables, values, objects). The backward flow analysis subsystem 206 can define a number of instructions that cause a modification to the attributes for the target property.

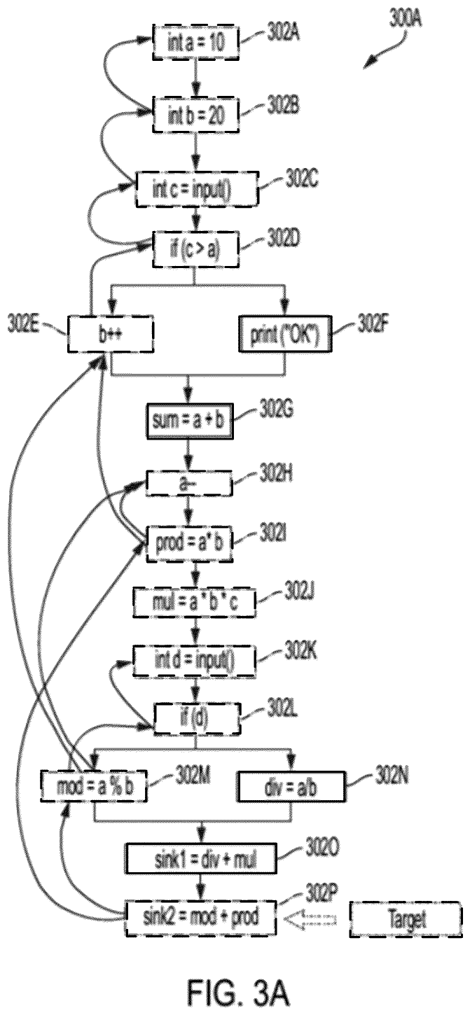

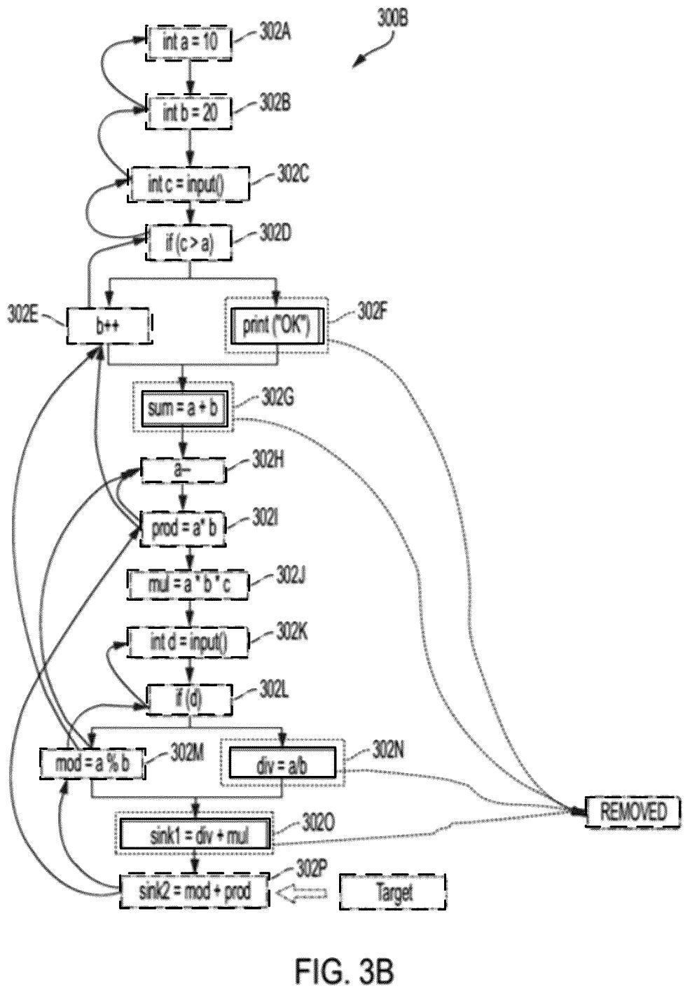

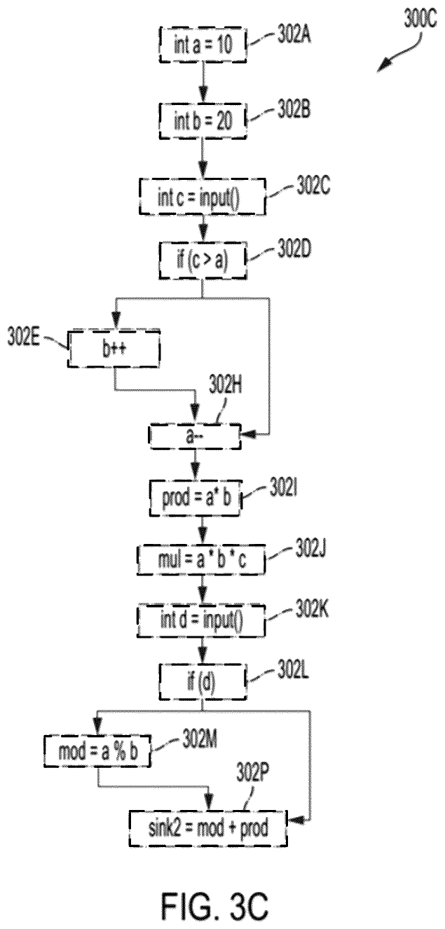

The backwards flow analysis can include identifying a first set of attributes that are part of the target property. For example, a target property can include an instruction (302P in FIGS. 3A-3C) with multiple attributes (e.g., variables ‘mod’ and ‘prod’). The backwards flow analysis can also include tracing dependencies of the one or more properties in the set of input source code. This can include identifying compute nodes that either read or write attributes and determining a subset of nodes or instructions that modify the target property. For instance, a set of instructions 302A, 302B, 302C, 302D, 302E, 302H, 302I, 302J, 302K, 302L, and 302M can be identified as modifying the attributes of the target property 302P in FIGS. 3A-3C. In some instances, identifying compute nodes that read or write variables further includes retrieving data for each of the compute nodes in a file structure and identifying a modification of any variable to the compute nodes in response to execution of each property.

The backwards flow analysis can include determining a subset of nodes/instructions that either include an identified compute node that writes to any attribute that modifies any of the first set of attributes in the target property or include a path that exists between a first compute node that writes a first attribute and a second compute node associated with the target property that reads the first attribute without the first attribute being redefined by any intervening compute node. In some instances, the backward flow analysis can include identifying a second subset of nodes or instructions that are processed subsequent to the target property and do not modify any of the first set of attributes that are part of the target property and identifying a third subset of nodes or instructions that include properties that only read data to one or more compute nodes. Any of the second subset of nodes or instructions and the third subset of nodes/instructions can be removed from consideration in performing the backward flow analysis for the target property.

The output code module generation subsystem 208 can generate output code modules as described herein. The output code modules can include text-based representations and/or graphical representations of the properties that modify or impact the target property. For instance, the output code module can include lines of code comprising instructions (e.g., 300C in FIG. 3C) that modify variables of a target property 302P.

In some instances, the output code modules can be represented based on a dependency tree of dependencies of a target property. In other instances, the output code module can be interactive, providing for a user to step through each instruction and identify nodes being written/read as each instruction is executed.

The output code module can be verified via a verification process as described herein. For instance, verification can include reviewing compute nodes for each instruction to be verified for accuracy during execution. Verification can also include tracking multiple attributes as a number of instructions are executed to debug and identify any undesirable results of any instruction. Verification can be manually performed by an operator or automatically using one or more tools for verifying an accuracy of code. Any of the output code module(s) and verification information can be transmitted to one or more remote computing devices for further analysis by users on the computing devices.

### Code Isolation Example 1

A first example of code isolation can include isolating code within a general software program. FIGS. 3A-3C illustrate an example flow process for isolating code for a software program. For instance, as shown in FIG. 3A, the flow diagram 300A can illustrate a set of instructions interconnected based on dependencies to one another.

Each block can represent an instruction 302A-O. For example, instruction 302A can specify integer ‘a’ by writing an integer value to variable ‘a,’ while instruction 302B can specify integer ‘b.’ Instruction 302C can specify integer ‘c’ as being an input. Further, instruction 302D can specify a conditional statement that has multiple responsive instructions 302E-F.

A target property 302P can include a statement of interest that can be the basis of code reduction and generation of an output code module as described herein. In this example, target property 302P includes an assignment statement that can comprise a sink instruction with a corresponding print instruction, and the target property 302P can be based on variables (otherwise referred to as attributes) ‘mod’ and ‘prod.’

As described above, dependencies of the target property (e.g., 302P) can be traced to identify each dependent statement as part of the backward flow analysis process. Moving to the illustration 300B in FIG. 3B, a portion of the statements can be removed as not being dependencies to the target property. For instance, instruction 302O specifies that ‘sink1’ is based on variables ‘div’ and ‘mul,’ which have no impact on relevant variables in target property 302P. As another example, instruction 302N modifies the ‘div’ variable and does not modify the attributes of the target property 302P. Additional statements 302F and 302G are not dependencies to target property 302P. Such instructions can be removed when generating an output code module.

FIG. 3C illustrates an example output code module 300C for target property 302P. As shown in FIG. 3C, the output code module 300C can remove non-dependent statements 302F, 302G, 302N, and 3020. The output code module 300C can allow for simplified tracing of all statements dependent to target property 302P and verification of each dependent statement.

### Code Isolation Example 2

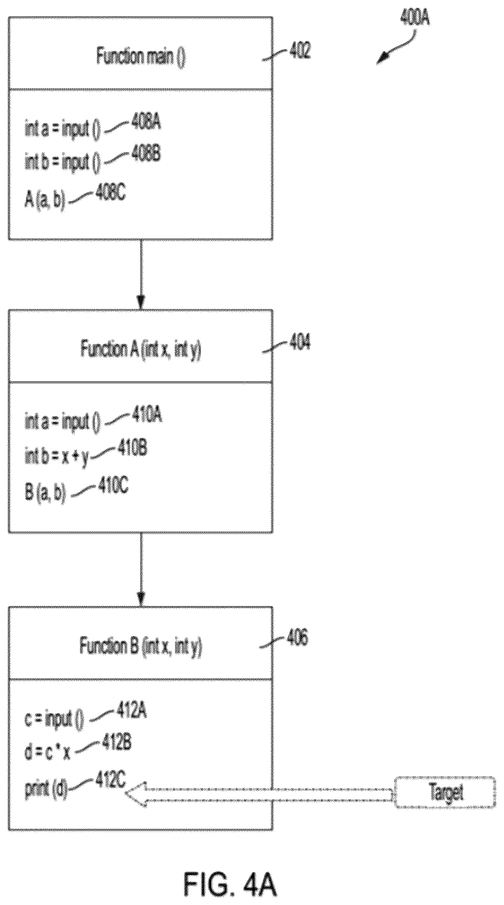

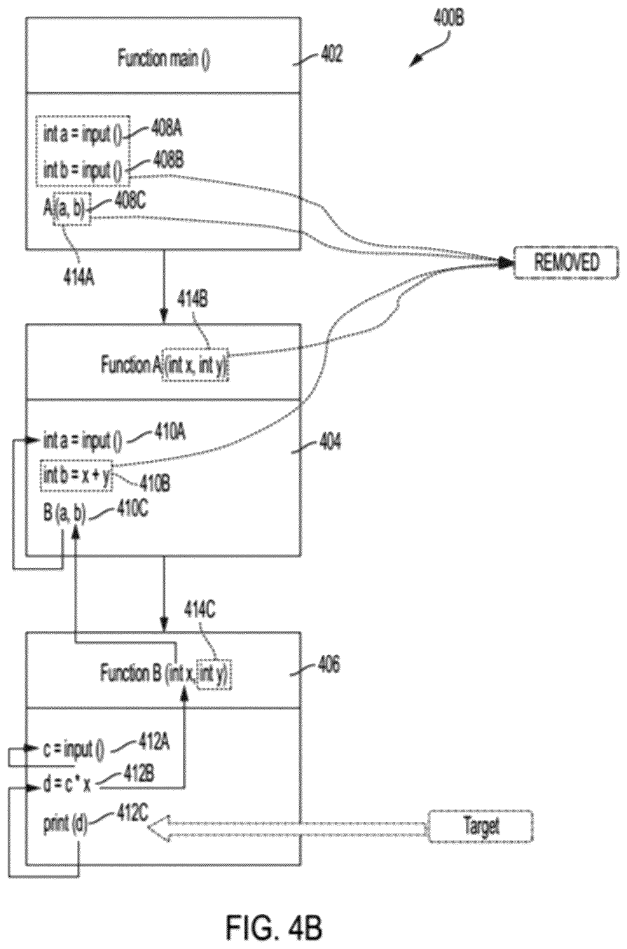

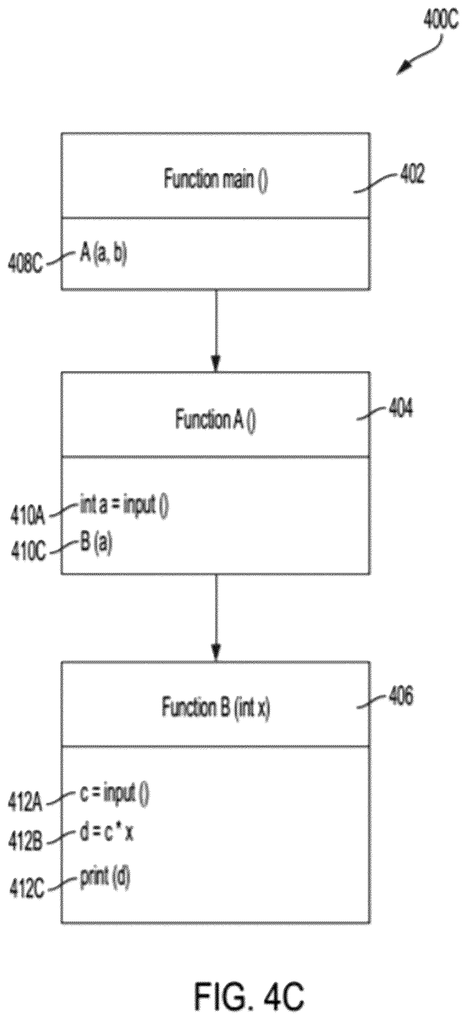

In another example, multiple instructions can be executed as part of software code comprising multiple functions. FIGS. 4A-4C illustrates a flow process of a second example for isolating code for a software program. As shown in FIG. 4A, an illustration 400A of a second example program can include multiple functions (e.g., Function main ( ) 402, Function A 404, and Function B 406). In this example, the main function 402 can define attributes ‘a’ (e.g., 408A), ‘b’ (e.g., 408B), and ‘A’ (e.g., 408C) that are fed into Function A 404. Function A 404 can modify attributes ‘a’ (e.g., 410A), ‘b’ (e.g., 410B) and ‘B’ (e.g., 410C). Function A 408C can call function A with attributes ‘a’ and ‘b’. Function B 406 defines a function call ‘c’ (e.g., 412A) and an attribute ‘d’ (e.g., 412B).

In this example, statement 412C is the target property that can be used as a target sink. As can be seen from FIG. 4A, property 412C can be to print integer ‘d’, so all properties dependent upon property 412C are to be identified. FIG. 4B is an illustration 400B of a tracing of all statements that are dependent to the target property 412C. For example, statement 412B defines variable ‘d’ as being based on variables ‘c’ and ‘x’, while statement 412A defines variable ‘c’, which are both dependent to variable ‘d’ in target property 412C. Function B 406 is fed integers ‘x’ and ‘y’, and only integer ‘x’ is dependent to the target property. Accordingly, integer ‘y’ and corresponding statement 410B are not dependent to the target statement. Further, in Function main ( ) 402, statements 408A-C are all not dependent to the target property, and therefore Function main ( ) 402 only calls function A at statement 414A. Statements 414B, 414C are also not dependent to the target property 412C.

FIG. 4C is an illustration 400C of a remaining subset of the input source code. In FIG. 4C, an output code module illustrating a portion of the input source code is shown. As shown in FIG. 4C, various statements have been removed, leaving statements 408C, 410A, 410C, and 412A-C.

Various rules can be used as part of the backwards flow analysis. For instance, a first rule can be described as follows. If a node does not affect the variables in the target property (e.g., the target to be verified), that node (and any associated instruction) is not to be included in the isolated code. Since read operations do not affect a variable or the value it holds, only write events may need to be included in the isolated code. Read events may not need to be considered for single threaded programs even under relaxed memory models as they have no side-effects in a single threaded program.

A second rule can be that nodes that occur after the property node can be dropped unless the node can reach the property through a backward edge, such as a loop. A third rule may be that, if a node N writes a variable ‘x’ read in the node P, include that node if there exists at least one path between N and P where x is not redefined. In one embodiment, one or more of these rules may be implemented.

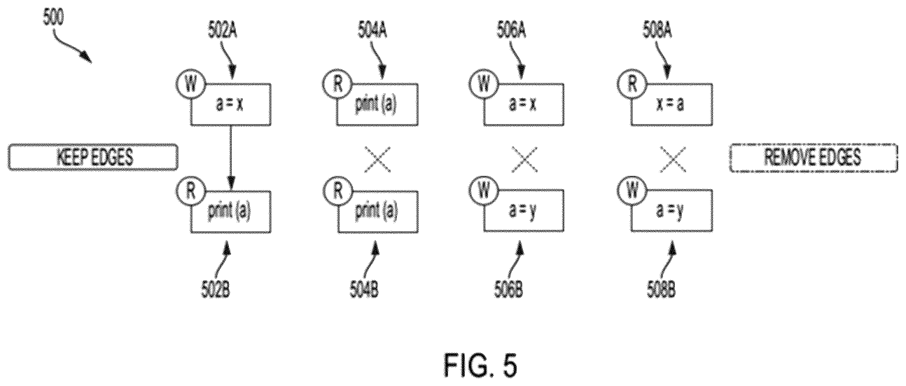

FIG. 5 illustrates an example set of nodes 500 and whether corresponding instructions are dependent to each target property. For instance, a first property 502A writes a value ‘a’ as being equal to ‘x’, with a corresponding target property 502B to print value ‘a’. In this case, the property is dependent to the target property, as value ‘a’ is modified in a write instruction in the first property 502A.

Further, a second property 504A is a read instruction (e.g., print value a), which does not modify the attribute of the target property (value ‘a’) 504B. A third property 506A can include a write instruction to define value ‘a’, with the target property 506B not being impacted by the third property 506A. A fourth property 508A can include a read instruction that does not modify the target property 508B. Therefore, in the example as shown in FIG. 5, only property 502A would be kept, and properties 504A, 506A, 508A are removed as part of the backward flow analysis.

The rules above can be implemented as an algorithm to programmatically construct a reduced code from data flow dependency for a target property. The following is an example illustration of such an algorithm:

| 1 | foreach sink/property node S ∈ Icode do | | | | |
|---|---|---|---|---|---|
| 2 | \| | curr ← S; | | | |
| 3 | \| | readset ← Operandread ∈ curr; | | | |
| 4 | \| | writeset ← Operandwrite ∈ curr; | | | |
| 5 | \| | Nodes ← Φ: | | | |
| 6 | \| | foreach prev ← prev(curr) do | | | |
| 7 | \| | \| | while prev ≠ null do | | |
| 8 | \| | \| | \| | if readset = Φ then | |
| 9 | \| | \| | \| | \| | break; |
| | \| | \| | \| | \|_{—} | |
| 10 | \| | \| | \| | if isBranchInst(prev) then | |
| 11 | \| | \| | \| | \| | readset ← readset ∪ (Operandread ∈ prev); |
| 12 | \| | \| | \| | \| | curr ← prev; |
| 13 | \| | \| | \| | \| | prev ← prev(prev); |
| 14 | \| | \| | \| | \| | continue; |
| | \| | \| | \| | \|_{—} | |
| 15 | \| | \| | \| | if (operandwrite ∈ prev) ∩ readset = Φ then | |
| 16 | \| | \| | \| | \| | curr ← prev; |
| 17 | \| | \| | \| | \| | prev ← prev(prev); |
| 18 | \| | \| | \| | \| | continue: |
| | \| | \| | \| | \|_{—} | |
| 19 | \| | \| | \| | else | |
| 20 | \| | \| | \| | \| | Nodes.add(curr); |
| 21 | \| | \| | \| | \| | readset ← readset − (Operandwrite ∈ prev); |
| 22 | \| | \| | \| | \| | writeset ← writeset − (Operandread ∈ prev); |
| 23 | \| | \| | \| | \| | curr ← prev; |
| 24 | \| | \| | \| | \| | prev ← prev(prev); |

| | | | |
|---|---|---|---|
| \| | \| | \| | \|_{—} |

| | | |
|---|---|---|
| \| | \| | \|_{—} |

| | |
|---|---|
| \| | \|_{—} |

|_{—}

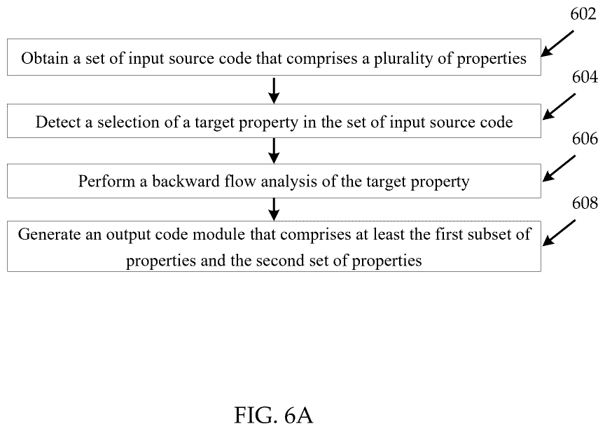

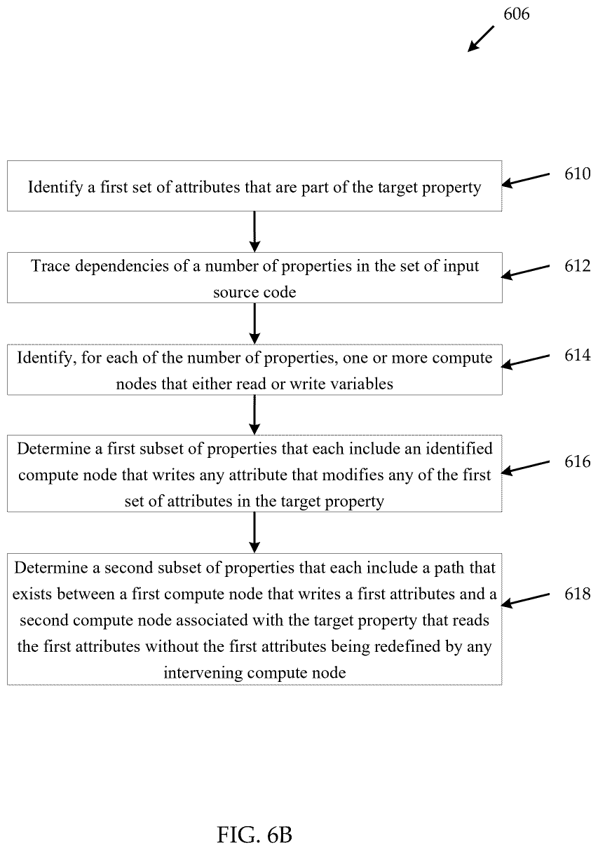

As described above, the present embodiments provide systems and methods for code isolation using a backwards flow analysis. FIGS. 6A-6B provide example flow processes for isolating code in a set of input source code using a backward flow analysis. At 602, a set of input source code is obtained that includes one or more properties (an attribute, variable, object, etc., in an instruction). The input source code can be obtained at a computer device performing the backward flow analysis or downloaded from another computing device. Further, the input source code can include instructions that each cause a read/write to one or more nodes.

At 604, a selection of a target property in the set of input source code can be detected. In a first example, a user can click on or otherwise specify a target property, such as an instruction in the input source code (e.g., instruction 302P in FIG. 3A) with one or more properties (e.g., variables). In another example, the target property can be automatically selected based on an instruction type (e.g., the instruction comprising a sink function). Further, multiple separate target properties can be selected, and an output code module can be generated for each separate target property.

At 606, a backward flow analysis can be performed for a target property. The backward flow analysis can trace all dependencies of the target property to identify all properties that impact or modify the target property. For example, as shown in FIGS. 3A-3C, instructions 302A-E, 302H-M are identified as being dependencies to the target property 302P. The backward flow analysis is discussed in greater detail with respect to FIG. 6B.

As shown in FIG. 6B, at 610, performing a backward flow analysis from the target property (606) on the input source code can include identifying a first set of attributes that are part of the target property. This can include identifying any object, variable, value, etc. associated with the target property. For example, in FIG. 3A, target property 302P includes variables ‘mod’ and ‘prod’. The backward flow analysis subsystem (e.g., 208) as described herein can identify these variables from the instruction and can identify compute nodes that are modified in response to execution of the target property.

At 612, performing a backward flow analysis from the target property can include tracing dependencies of one or more properties in the set of input source code. This can include tracing each attribute of the target property backwards in the input source code to identify each instruction that modifies any of the target properties. For example, a dependency tree can be generated tracing each attribute of the target property. As shown in FIG. 3B, for example, tracing a dependency for the ‘mod’ variable in target property 302P can be traced to statement 302M that modifies the ‘mod’ variable as including values ‘a’ and ‘b’. Further, in this example, other statements modify values ‘a’ and ‘b’, such as statement 302E that modifies value ‘b’ and statement 302H that modifies value ‘a’, for example.

At 614, performing a backward flow analysis from the target property can include identifying, for each of the one or more properties, one or more compute nodes that either read or write attributes. The backward flow analysis subsystem (e.g., 208) can parse each instruction in a set of input code to identify compute nodes of a computer that are modified in response to execution of each instruction. For instance, an instruction can cause a read of a first node to retrieve a current value for a variable and a write to a second node to modify that variable.

In some instances, identifying compute nodes that read or write variables further includes retrieving data for each of the compute nodes and identifying a modification of any variable to the compute nodes in response to execution of each property. For example, a computer can parse a file structure specifying locations of compute nodes and can determine modification of compute nodes in response to execution of each instruction.

At 616, performing a backward flow analysis of the target property can include determining a subset of nodes or instructions that include an identified compute node that writes to any attribute that modifies any of the first set of attributes in the target property. The subset of nodes or instructions can include a number of properties (and associated instructions in the input source code) that modify any of the attributes of the target property. For example, in FIG. 3B, the backward flow analysis can identify a subset of nodes or instructions as statements 302A-E, 302H-M as affecting the attributes (e.g., variables ‘mod’ and ‘prod’) in the target property 302P.

At 618, performing a backward flow analysis of the target property can include identifying properties with a path between a first compute node that writes a first attribute and a second compute node associated with the target property that reads the first attribute without the first attribute being redefined by any intervening compute node. For example, if a first instruction causes a write of a variable to a first value and the target property includes an instruction to read the variable, the first instruction can be dependent to the target property so long as no intervening instruction causes a modification to the variable.

In some instances, the backward flow analysis further comprises identifying a second subset of instructions that are processed subsequent to the target property and do not modify any of the first set of attributes that are part of the target property and removing each of the second subset of nodes or instructions from the number of properties to be traced as part of the backward flow analysis for the target property. As an illustrative example, if a target property is instruction 302J in FIG. 3A, instructions 302K-P would be executed after the target property and would not modify the target property unless there is a loop that exists back to the target property. Such properties do not need to be included in the backward flow analysis to improve processing efficiency.

In some instances, the backward flow analysis further comprises identifying a third subset of nodes or instructions that include properties that only read data to one or more compute nodes and removing each of the third subset of nodes or instructions from the number of properties to be traced as part of performing the backward flow analysis for the target property. For example, in FIG. 3A, instruction 302F is an instruction to ‘print’ text ‘OK’, which comprises a read instruction and no write instructions. Accordingly, in this example, even if the instruction 302F was printing an attribute of a target property 302P, such an instruction may not be included in the output code module as only a read instruction is being performed.

At 608, the method can include generating an output code module that comprises at least the subset of nodes or instructions. The output code module can include a text-based representation of the subset of nodes or instructions.

For example, the output code module can allow for an operator to review and verify instructions in the output code module as part of a verification process. The verification process can include any of an automatic or manual process to review each instruction and determine whether read/write instructions to compute nodes are as expected when executing each instruction. Automatic verification processes can include performing a parsing or NLP process on each instruction, identifying corresponding compute nodes, and determining whether an actual modification to the compute nodes matches what is expected to result from execution of the instruction.

In some instances, the method can include identifying the target property as a first instruction, identifying at least one other instruction in the set of input source code, and generating, for each identified instruction, output code modules using the backward flow analysis with attributes specific to each instruction. For example, a first target property can include a first sink instruction 302P, and a second target property can include a second sink instruction 302O in FIG. 3A. In this example, a backward flow analysis can be performed on each of the first sink instruction 302P and the second sink instruction 302O to generate output code modules unique to each sink instruction 302P, 302O. In some instances, the selection of target properties can be done either by selection by a user or automatically based on instruction type in the input source code. Performing backwards flow analysis on multiple separate targets as described herein can increase efficiency in performing verification on large software programs.

### Computing System Overview

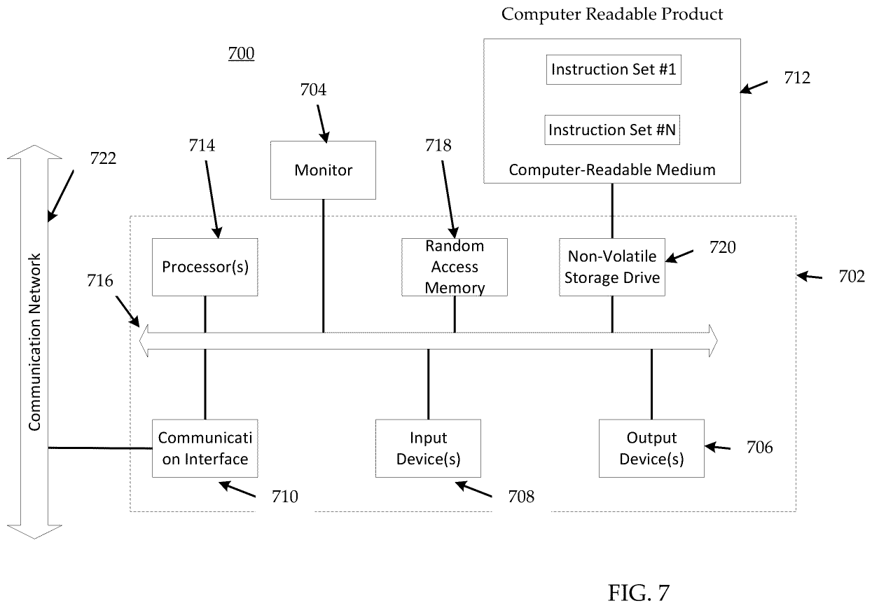

FIG. 7 is a block diagram of a special-purpose computer system 700 according to an embodiment. The computer-implemented methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 700 comprises a computer 702, a monitor 704 coupled to computer 702, one or more additional user output devices 706 (optional) coupled to computer 702, one or more user input devices 708 (e.g., keyboard, mouse, track ball, touch screen) coupled to computer 702, an optional communications interface 710 coupled to computer 702, and a computer-program product including a tangible computer-readable storage medium 712 in or accessible to computer 702. Instructions stored on computer-readable storage medium 712 may direct system 700 to perform the methods and processes described herein. Computer 702 may include one or more processors 714 that communicate with a number of peripheral devices via a bus subsystem 716. These peripheral devices may include user output device(s) 706, user input device(s) 708, communications interface 710, and a storage subsystem, such as random-access memory (RAM) 718 and non-volatile storage drive 720 (e.g., disk drive, optical drive, solid state drive), which are forms of tangible computer-readable memory.

Computer-readable medium 712 may be loaded into random access memory 718, stored in non-volatile storage drive 720, or otherwise accessible to one or more components of computer 702. Each processor 714 may comprise a microprocessor, such as a microprocessor from Intel® or Advanced Micro Devices, Inc.®, or the like. To support computer-readable medium 712, the computer 702 runs an operating system that handles the communications between computer-readable medium 712 and the above-noted components, as well as the communications between the above-noted components in support of the computer-readable medium 712. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 708 include all possible types of devices and mechanisms to input information to computer system 702. These may include a keyboard, a keypad, a mouse, a scanner, a digital drawing pad, a touch screen incorporated into the display, audio input devices such as voice recognition systems, microphones, and other types of input devices. In various embodiments, user input devices 708 are typically embodied as a computer mouse, a trackball, a track pad, a joystick, wireless remote, a drawing tablet, a voice command system. User input devices 708 typically allow a user to select objects, icons, text and the like that appear on the monitor 704 via a command such as a click of a button or the like. User output devices 706 include all possible types of devices and mechanisms to output information from computer 702. These may include a display (e.g., monitor 704), printers, non-visual displays such as audio output devices, etc.

Communications interface 710 provides an interface to other communication networks and devices and may serve as an interface to receive data from and transmit data to other systems, WANs and/or the Internet, via a wired or wireless communication network 722. In addition, communications interface 710 can include an underwater radio for transmitting and receiving data in an underwater network. Embodiments of communications interface 710 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 710 may be coupled to a computer network, to a Fire Wire® bus, or the like. In other embodiments, communications interface 710 may be physically integrated on the motherboard of computer 702, and/or may be a software program, or the like.

RAM 718 and non-volatile storage drive 720 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 718 and non-volatile storage drive 720 may be configured to store the basic programming and data constructs that provide the functionality of various embodiments of the present invention, as described above.

Software instruction sets that provide the functionality of the present invention may be stored in computer-readable medium 712, RAM 718, and/or non-volatile storage drive 720. These instruction sets or code may be executed by the processor(s) 714. Computer-readable medium 712, RAM 718, and/or non-volatile storage drive 720 may also provide a repository to store data and data structures used in accordance with the present invention. RAM 718 and non-volatile storage drive 720 may include a number of memories including a main random-access memory (RAM) to store instructions and data during program execution and a read-only memory (ROM) in which fixed instructions are stored. RAM 718 and non-volatile storage drive 720 may include a file storage subsystem providing persistent (non-volatile) storage of program and/or data files. RAM 718 and non-volatile storage drive 720 may also include removable storage systems, such as removable flash memory.

Bus subsystem 716 provides a mechanism to allow the various components and subsystems of computer 702 communicate with each other as intended. Although bus subsystem 716 is shown schematically as a single bus, alternative embodiments of the bus subsystem may utilize multiple busses or communication paths within the computer 702.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine or computer-readable code recorded on a machine or computer-readable medium. In some embodiments, the computer-readable computer may be a non-transitory computer-readable medium. Examples of such a non-transitory computer-readable medium include but are not limited to a read-only memory, a random-access memory, a flash memory, a CDROM, a DVD, a magnetic tape, a removable memory card, and optical data storage devices. In other embodiments, the computer-readable medium may be a transitory computer-readable medium. In such embodiments, the transitory computer-readable medium can be distributed over network coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A computer-implemented method for isolating a portion of input source code using a backward flow analysis, the computer-implemented method comprising:
obtaining a set of input source code that comprises one or more properties;
detecting a selection of a target property in the set of input source code;
performing a backward flow analysis of the target property including:
identifying a first set of attributes that are part of the target property;
tracing dependencies of the one or more properties in the set of input source code;
identifying, for each of the one or more properties, one or more compute nodes that either read or write attributes; and
determining a subset of nodes or instructions that: (i) include an identified compute node that writes to any attribute that modifies any of the first set of attributes in the target property or (ii) include a path between a first compute node that writes a first attribute and a second compute node associated with the target property that reads the first attribute without the first attribute being redefined by any intervening compute node; and
generating an output code module that comprises at least the subset of nodes or instructions.

2. The computer-implemented method of claim 1, wherein the backward flow analysis further comprises:
identifying a second subset of nodes or instructions that are processed subsequent to the target property and do not modify any of the first set of attributes that are part of the target property; and
removing each of the second subset of nodes or instructions in performing the backward flow analysis for the target property.

3. The computer-implemented method of claim 1, wherein the backward flow analysis further comprises:
identifying a third subset of nodes or instructions that include properties that only read data to one or more compute nodes; and
removing each of the third subset of nodes or instructions in performing the backward flow analysis for the target property.

4. The computer-implemented method of claim 1, wherein identifying compute nodes that read or write variables further includes:
retrieving data for each of the compute nodes in a file structure; and
identifying a modification of any variable to the compute nodes in response to execution of each property.

5. The computer-implemented method of claim 1, further comprising:
performing a verification process of the output code module.

6. The computer-implemented method of claim 1, wherein the output code module includes a text-based graphical representation of the subset of nodes or instructions.

7. The computer-implemented method of claim 1, wherein the output code module is a text-based representation of each of the first subset of nodes or instructions and the second subset of nodes or instructions.

8. The computer-implemented method of claim 1, further comprising:
identifying the target property as a first instruction;
identifying at least one other instruction in the set of input source code; and
generating, for each identified instruction, output code modules using the backward flow analysis with attributes specific to each instruction.

9. A computer-readable storage medium containing program instructions for a method being executed by an application, the application comprising code for one or more components that are called by the application during runtime, wherein execution of the program instructions by one or more processors of a computer system causes the one or more processors to perform steps comprising:
obtaining a set of input source code that comprises one or more properties;
detecting a selection of a target property in the set of input source code;
performing a backward flow analysis of the target property including:
identifying a first set of attributes that are part of the target property;
tracing dependencies of a number of the one or more properties in the set of input source code;
identifying a first subset of nodes or instructions that are processed subsequent to the target property and do not modify any of the first set of attributes that are part of the target property;
identifying a second subset of nodes or instructions that include properties that only read attributes to one or more compute nodes;
removing each of the first subset of nodes or instructions and the second subset of nodes or instructions from properties considered in performing the backward flow analysis for the target property;
determining a third subset of nodes or instructions that each include an identified compute node that writes any attribute that modifies any of the first set of attribute in the target property and a fourth subset of nodes or instructions that each include a path between a first compute node that writes a first attribute and a second compute node associated with the target property that reads the first attribute without the first attribute being redefined by any intervening compute node; and
generating an output code module that comprises at least the third subset of nodes or instructions and the fourth set of nodes or instructions.

10. The computer-readable storage medium of claim 9, wherein identifying compute nodes that read or write variables further includes:
retrieving data for each of the compute nodes in a file structure; and
identifying a modification specifying a read or write of any attribute to the compute node in response to execution of each property.

11. The computer-readable storage medium of claim 9, wherein execution of the program instructions further causes the one or more processors to perform steps comprising:
performing a verification process of the output code module.

12. The computer-readable storage medium of claim 9, wherein the output code module includes a graphical representation of each property and a representation of a modification of each compute node as each property is executed.

13. The computer-readable storage medium of claim 9, wherein the output code module is a text-based representation of each of the third subset of nodes or instructions and the fourth subset of nodes or instructions.

14. The computer-readable storage medium of claim 9, wherein execution of the program instructions further causes the one or more processors to perform steps comprising:
identifying the target property as a first instruction;
identifying at least one other instruction in the set of input source code; and
generating, for each identified instruction, output code modules unique to each instruction using the backward flow analysis with variables specific to each instruction.

15. A method comprising:
obtaining a set of input source code that comprises one or more properties;
detecting a selection of a target property in the set of input source code;
performing a backward flow analysis of the target property including:
identifying a first set of variables that are part of the target property;
tracing dependencies of a number of properties in the set of input source code;
identifying, for each of the number of properties, one or more compute nodes that either read or write variables;
determining a first subset of nodes or instructions that each include an identified compute node that writes any variable that modifies any of the first set of variables in the target property; and
determining a second subset of nodes or instructions that each include a path that exists between a first compute node that writes a first variable and a second compute node associated with the target property that reads the first variable without the first variable being redefined by any intervening compute node; and
generating an output code module that comprises at least the first subset of nodes or instructions and the second set of nodes or instructions.

16. The method of claim 15, wherein the backward flow analysis further comprises:
identifying a third subset of nodes or instructions that are processed subsequent to the target property and do not modify any of the first set of variables that are part of the target property;
identifying a fourth subset of nodes or instructions that include properties that only read variables to one or more compute nodes; and
ignoring each of the third subset of nodes or instructions and the fourth set of nodes or instructions from being considered in performing the backward flow analysis for the target property.

17. The method of claim 16, wherein identifying, for each of the number of properties in the set of input source code, compute nodes that read or write variables further includes:
retrieving data for each of the compute nodes in a file structure; and
identifying a modification specifying a read or write of any variable to the compute node in response to execution of each property.

18. The method of claim 16, wherein the output code module is a text-based representation of each of the first subset of nodes or instructions and the second subset of nodes or instructions.

19. The method of claim 16, further comprising:
identifying the target property as a first instruction;
identifying at least one other instruction in the set of input source code; and
generating, for each identified instruction, output code modules using the backward flow analysis with attributes specific to each instruction.

20. The method of claim 16, further comprising:
performing a verification process of the output code module.
